(19) United States
(12) Patent Application Publication
(10) Pub. No.: US 2005/0144151 A1
(43) Pub. Date: Jun. 30, 2005

(54) System and method for decision analysis and resolution

(76) Inventors: Reuben S. Fischman, Rehoboth, MA (US); Adam Payne, Franklin, MA (US); Melissa Wills, Bellingham, MA (US)

Correspondence Address: HOWREY SIMON ARNOLD & WHITE, LLP, c/o IP DOCKETING DEPARTMENT, 2941 FAIRVIEW PARK DRIVE, SUITE 200, FALLS CHURCH, VA, 22042-2924, US

(21) Appl. No.: 10/817,071

(22) Filed: Apr. 1, 2004

Related U.S. Application Data
(60) Provisional application No. 60/459,801, filed on Apr. 2, 2003.

(51) Int. Cl. G06N 5/00

(52) U.S. Cl. 706/45

(57) ABSTRACT

A system and method for analyzing and resolving events within a computer network. The method for analyzing and resolving events within a computer network may include the steps of detecting an event, analyzing the event to determine a root cause for the event; relating a solution to the event based on the root cause; determining whether the solution can resolve the event automatically; automatically resolving the event when the event can be resolved automatically; and providing information for resolving the event to a user when the event cannot be resolved automatically.

### CROSS-REFERENCE TO RELATED APPLICATIONS

This application claims priority to copending U.S. provisional application entitled “Taking Aim with Dart: An Object-Oriented Approach to Automated Decision Analysis and Resolution Technology for NETOPS,” having Ser. No. 60/459,801, filed Apr. 1, 2003, which is entirely incorporated herein by reference.

### FIELD OF THE INVENTION

The invention generally relates to computer network technology and, more specifically, to a system and method for resolving events within a computer network.

### BACKGROUND

Computer networks for many applications are evolving to become more mobile and decentralized. One such application for computer networks is that of battlefield management. Current battlefield management computer networks have addressed to varying extents the fusion of network management systems, information assurance systems, and information dissemination management systems from the perspective of providing a comprehensive status of the deployed network. To some extent, current battlefield management computer networks incorporate some status monitoring and fault analysis systems. However, the mobile and unpredictable nature of computerized battlefield management networks calls for new troubleshooting and fault resolution systems and methods.

For an example of event analysis and display technology, see U.S. patent application entitled “Method and System for Modeling, Analysis and Display of Network Security Events,” having application Ser. No. 10/279,330, filed Oct. 24, 2002, and published on May 22, 2003, which is entirely incorporated herein by reference. For an example of a commonly used definition for management information systems see the Common Information Model, which is known to those having ordinary skill in the art and is entirely incorporated herein by reference. While current systems may interface with an event management system, they generally do not provide a significant level of assistance to users responding to events, such as fault events. Typically, such systems correlate a root cause for a fault event and open a trouble ticket to track the process of resolving the fault event.

In typical computer networks, when an event is detected, the operator is alerted, a trouble ticket is opened, and if necessary, the ticket is escalated to a qualified individual. Finally, a user or operator resolves the issue and the trouble ticket is closed. Throughout this process, operators may make annotations to the ticket, indicating steps taken towards problem resolution. During the time it takes to isolate one fault event and resolve it, any other events of varying severity can be detected, especially in a large, dynamic network. This can quickly result in significant service and network availability problems, as well as information overload for the operator or user responsible for resolving the fault event.

Prior art computer networks require a significant level of operator expertise, despite the inclusion of root-cause analysis software for automation of fault event identification. Operators require appropriate training and experience, capability to determine or recall appropriate solutions, and an infrastructure enabling escalation of issues to more experienced operators in order to arrive at proper resolutions to identified events. Even among expert operators, there is a significant cognitive burden associated with network operations due to the manual nature of the resolution process.

As a computer network's users become more dependent on shared information and converged networks continue to increase, particularly in the field of battlefield computer networks, the ability to accurately and quickly diagnose problems across the entire infosphere becomes critical. However, due to the complexity and high operational tempo of such networks, system support must extend beyond problem identification to assist operators with problem resolution. Such assistance is critical to end-to-end system availability and successful mission execution.

### SUMMARY OF THE INVENTION

A system and method for resolving events within a computer network is provided. The system for resolving events include a resolution module, and a solution module. The resolution module may be configured to generate a proposed response to the detected event. And, the solution module may be configured to resolve the detected event using the proposed response. The resolution module is configured to cooperate with the solution module to automatically implement the proposed response and the resolution module is configured to cooperate with the solution module to present the proposed response as a suggested response to resolve the detected event.

The method for resolving events within a computer network may include the steps of relating a solution to the root cause, determining whether the solution can resolve the event automatically, automatically resolving the event when the event can be resolved automatically, and providing information for resolving the event to a user when the event cannot be resolved automatically.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### DESCRIPTION OF THE FIGURES

The invention can be better understood with reference to the following figures. The components in the figures are not necessarily to scale, emphasis instead being placed upon a clearly illustrating the principles of the present invention. Moreover, in the drawings, like reference numerals designate corresponding parts throughout the several views.

FIG. 1 is a block diagram of a computer network including a plurality of remote computers, a data transportation system, a plurality of management computers, and a plurality of datastores.

FIG. 2 is a block diagram of a computer. The computer of FIG. 2 may be any computer within the network of FIG. 1. The computer of FIG. 2 includes a memory element. The memory element includes a decision analysis and resolution system. The memory element may be configure to practice the decision analysis and resolution method

FIG. 3 is a flowchart showing one embodiment of the decision analysis and resolution system of FIG. 2.

### DETAILED DESCRIPTION OF THE INVENTION

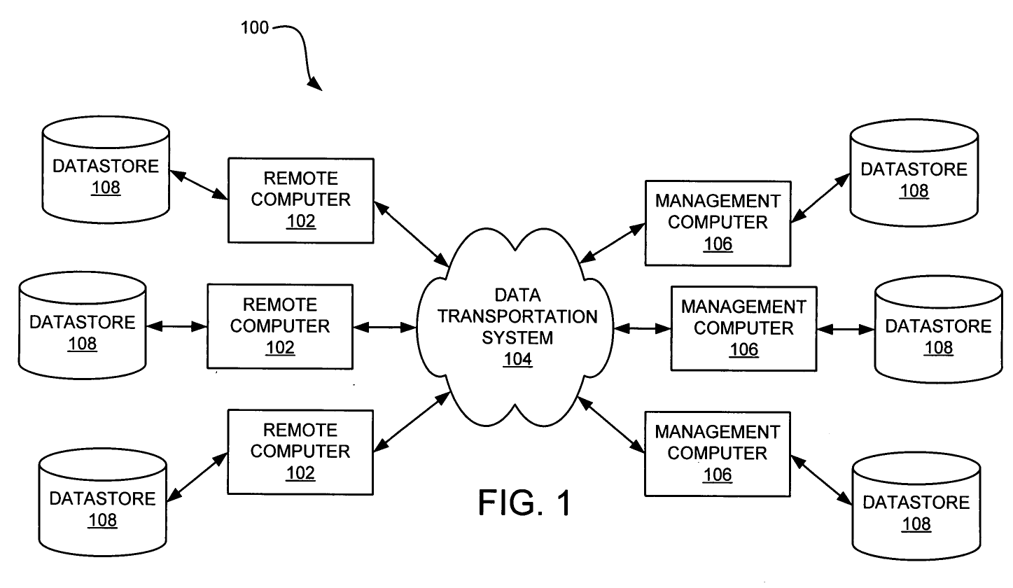

FIG. 1 is a block diagram of a computer network 100, including a plurality of remote computers 102, a data transportation system 104, a plurality of management computers 106, and a plurality of datastores 108, where the datastores may be any means of storing data including, but not limited to a database and a directory. Computers 102 and 106 and datastore 108 may be communicatively coupled in the network 100 through the data transportation system 104 and/or directly in communication with each other. The data transportation system 104 employs various wired and wireless technologies known to those having ordinary skill in the art. While the invention may be practiced in a variety of networks, it is described herein in regard to an object-oriented battlefield management system.

Data transportation system 104 may include a large number of data transfer technologies known by those having ordinary skill in the art such as, but not limited to, asynchronous transfer modes and Gigabit Ethernet topologies and other data transfer technologies known to be in use by the Defense Information Systems Agency. Data transportation system 104 may include the use of the Internet.

The decision analysis and resolution system 212 allows computer networks 100, such as battlefield management systems, to extend beyond the current limitations, to include fault resolution. As such, the system 212 resolves faults automatically when possible and guides users through fault resolution when an automated response is not viable. Since the subject matter expertise needed to address a fault is often not readily available in a deployed environment, the decision analysis and resolution system 212 may bring the knowledge of the subject matter expert to the deployed forces.

The decision analysis and resolution system 212 relates network elements, including services, infrastructure and security elements, to the identified events, such as fault events, that affect them, and subsequently relating those events to automated solutions, or suggested corrective actions. The decision analysis and resolution system 212 provides automated analysis and comprehensive information across network 100 domains. The decision analysis and resolution system 212 also provides assistance during the resolution of an event.

In one embodiment, computer network 100 includes object-oriented representations of the relationships between network 100 components, services, security, and infrastructure. In this embodiment, the object-oriented representations are extended to relate the network 100 components, services, security and infrastructure to identified events that affect them, and subsequently relate those events to automated actions or suggested actions. In the case of fault events, the object-oriented representations are extended to relate the network 100 components, services, security and infrastructure to the identified faults and to relate the fault to automated solutions or suggested corrective actions.

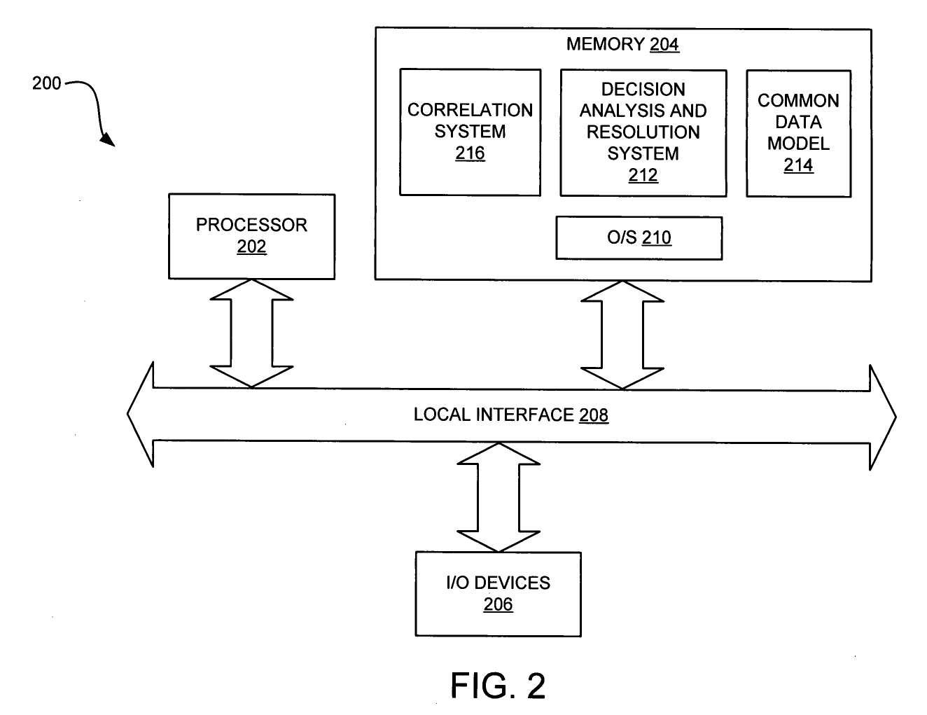

The decision analysis and resolution system 212 (FIG. 2) can be implemented in software (e.g., firmware), hardware, or a combination thereof. In one embodiment, the decision analysis and resolution system 212 is implemented in software, as an executable program, and is executed by a special or general purpose digital computer, such as, but not limited to, a personal computer (PC; IBM-compatible, Apple-compatible, or otherwise), workstation, minicomputer, personal digital assistant, and a mainframe computer.

FIG. 2 is a block diagram of a computer 200. Computer 200 may be any computer within network 100 including remote computers 102 and management computers 106. Generally, in terms of hardware architecture, as shown in FIG. 2, the computer 100 includes a processor 202, memory element 204, and one or more input and/or output (I/O) devices 206 (or peripherals) that are communicatively coupled via a local interface 208. Memory element 204 includes an operating system 210, an decision analysis and resolution system 212, a common data model 214, and a correlation system 216. Memory element 204 may be configured to practice the decision analysis and resolution method.

Local interface 208 can be, for example, one or more buses or other wired or wireless connections, as is known in the art. Local interface 208 may have additional elements, which are omitted for simplicity, such as controllers, buffers (caches), drivers, repeaters, and receivers, to enable communications. Further, local interface 208 may include address, control, and/or data connections to enable appropriate communications among the aforementioned components.

Processor 202 is a hardware device for executing software, particularly software stored in memory 204. Processor 202 can be any custom made or commercially available processor, a central processing unit (CPU), an auxiliary processor among several processors associated with computer 100, a semiconductor based microprocessor (in the form of a microchip or chip set), a macroprocessor, or generally any device for executing software instructions. Suitable commercially available microprocessors include: PA-RISC series microprocessors from Hewlett-Packard Company, U.S.A.; 80X86 or Pentium series microprocessors from Intel Corporation, U.S.A.; PowerPC microprocessors from IBM, U.S.A.; Sparc microprocessors from Sun Microsystems, Inc.; and 68XXX series microprocessors from Motorola Corporation, U.S.A.

Memory 204 may include one or more memory elements such as volatile memory elements (e.g., random access memory (RAM, such as DRAM, SRAM, SDRAM, etc.)) and nonvolatile memory elements (e.g., ROM, hard drive, tape, CDROM, etc.). Memory 204 may also incorporate electronic, magnetic, optical, and/or other types of storage media. Memory 204 may have a distributed architecture, where various components are situated remote from one another, but can be accessed by processor 202.

The software in memory element 204 may include one or more separate programs, each of which comprises an ordered listing of executable instructions for implementing logical functions. In the example of FIG. 2, the software in memory 204 includes the decision analysis and resolution system 212 and a suitable control operating system (O/S) 210. Control operating system 210 may include portions of commercially available operating systems such as: (a) a Windows operating system available from Microsoft Corporation, including Windows NT and WIN 2000; (b) a Netware operating system available from Novell, Inc., such as, but not limited to, NetWare; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; (g) an appliance-based operating system, such as that implemented in handheld computers or personal data assistants (PDAs) (e.g., PalmOS available from Palm Computing, Inc., and Windows CE available from Microsoft Corporation); and (h) control systems that may run under other control system, such as, but not limited to Oracle8i and Oracle9i running under UNIX. Control operating system 210 essentially controls the execution of other computer programs and provides scheduling, input-output control, file and data management, memory management, and communication control and related services.

The I/O devices 206 may include input devices, for example but not limited to, a keyboard, a mouse, scanners, microphones, touchscreens, electronics scanners and readers, etc. Furthermore, the I/O devices 206 may also include output devices, for example but not limited to a printer, display, etc. Finally, I/O devices 206 may further include devices that communicate both inputs and outputs, for instance a modulator/demodulator (modem; for accessing another device, system, or network), a radio frequency (RF) or other transceiver, a telephonic interface, a bridge, a router, and network connections, etc.

If computer 200 is a personal computer, the software in memory element 204 may further include a basic input output system (BIOS) (not shown in the drawings for simplicity). The BIOS is a set of software routines that initialize and test hardware at startup, start the control operating system 210, and support the transfer of data among the hardware devices.

When computer 200 is in operation, processor 202 is configured to execute software stored within memory element 204, to communicate data to and from the memory element 204, and to generally control operations of computer 200 pursuant to the software. The decision analysis and resolution system 212 and the control operating system 210, in whole or in part, but typically the latter, are read by the processor 202, perhaps buffered within the processor 202, and then executed.

When the decision analysis and resolution system 212 is implemented in software, as is shown in FIG. 2, it should be noted that the decision analysis and resolution system 212 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The decision analysis and resolution system 212 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires; a portable computer diskette (magnetic); a random access memory (RAM) (electronic); a read-only memory (ROM) (electronic); an erasable programmable read-only memory (EPROM, EEPROM, or Flash memory) (electronic); an optical fiber (optical); and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the decision analysis and resolution system 212 is implemented in hardware, the decision analysis and resolution system 212 can be implemented with any or a combination of the following technologies, which are each well known in the art: a discrete logic circuit(s) having logic gates for implementing logic functions upon data signals; an application specific integrated circuit (ASIC) having appropriate combinational logic gates; a programmable gate array(s) (PGA); a field programmable gate array (FPGA); etc.

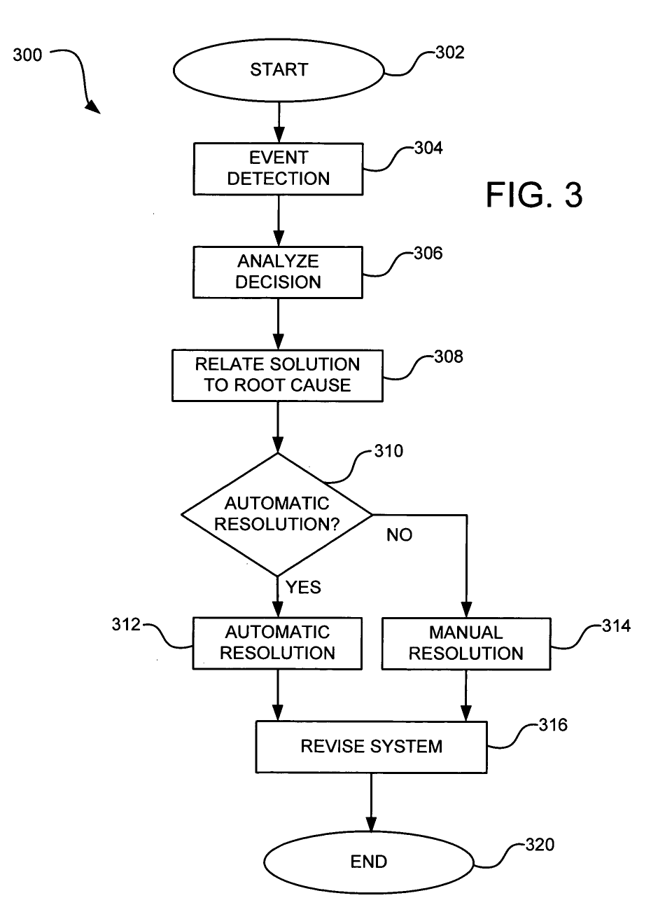

FIG. 3 is a flowchart showing one embodiment of the decision analysis and resolution system 212. In block 302, the decision analysis and resolution system 212 is started. The system may be called upon startup of computer 200, and/or the system may be trigger through any of numerous means of triggering a program known to those having ordinary skill in the art, such as but not limited to clicking on an icon. After block 302, the decision analysis and resolution system 212 goes to block 304.

In block 304, decision analysis and resolution system 212 detects an event in the network 100. The event may be detected automatically and/or the event may be detected by a user who provides input to the network 100 indicating an event has taken place. The system 212 may allow manual generation of trouble tickets for circumstances where an issue is known by a user, but no event has been detected in network 100. The event may be any occurrence within the network 100 that the network 100 recognizes as an event. In one embodiment, the event is a fault event. In an object-oriented network 100, objects may be used to represent monitoring concepts. After block 304, the decision analysis and resolution system 212 goes to block 306.

In block 306, the decision analysis and resolution system 212 analyzes the decision. In block 304, the events may be input to correlation system 216. The correlation system 216 may analyze events and decisions through root cause analysis. In an object-oriented network 100, objects are used to represent resolution concepts that relate to counterpart monitoring concepts. Block 306 may include the use of common data model 214. Common data model 214 facilitates the analysis of data stored within the network 100. In block 304, the system 212 may utilize the common data model 214 to perform fault analysis across a wide variety of data and problem domains to isolate a “root cause.” Those having ordinary skill in the art are familiar with representing normalized events and the nodes on which they occur as objects related to one another. After block 306, the decision analysis and resolution system 212 goes to block 308.

In block 308, the decision analysis and resolution system 212 utilizes object-oriented information to relate solutions to root causes for the events in a unified context. A solutions catalog may allow users to explore resolutions even without the occurrence of an event. Automated analysis of solutions provides a user or operator an understanding of the potential for success of a solution.

In block 308, normalized representations of events can be related to the network 100 elements the events affect and to a series of solutions that resolve the events. In block 308, the system 212 reduces the number of potential solutions the operator must consider. In one embodiment, solutions for events are created in the system 212 by instantiating objects of the appropriate class. A series of resolution steps may be related to multiple solutions. In this manner, a series of solution objects can be chained together using relationships such as “NextStep” and “PreviousStep” to create unique solutions for identified events.

As an example embodiment, an event such as “PowerSupplyFailure” on router “Router A” is identified as the root cause of a series of events. By utilizing relationships in an object-oriented approach, the system 212 relates the event “PowerSupplyFailure” to “Router A” as an “OccursOn” relationship. There may be several possible solutions to this problem. One solution could be “CheckPowerSupplyCable” which includes the series of steps required to accomplish this solution. Another solution might be “ReplacePowerSupply.” The “ReplacePowerSupply” solution may contain its own series of steps and may have some in common with the “CheckPowerSupplyCable” solution, such as a step for “TurnOffPowerSwitch.” In addition to providing this relationship between network 100 elements, problems and solutions, the system 212 may also interoperate with trouble ticket systems to provide a means of tracking the event across its lifecycle. After block 308, the decision analysis and resolution system 212 goes to block 310.

In block 310, the decision analysis and resolution system 212 determines whether the system 212 can automatically resolve the event. In block 308, the system 212 may create a relationship to that event within the common data model 214. In block 310, the system 212 collects and correlates data in order to determine whether the system 212 can resolve the event automatically. The determination of whether the system 212 can automatically resolve the event may be made based upon the root-cause identified in block 304. In one embodiment, a root cause of “high bandwidth utilization” may result in a determination that the system 212 can automatically resolve the event through rerouting of traffic and load balancing.

The system 212 may utilize the intelligence of the underlying object-oriented constructs and their relationships to evaluate the validity of a potential response. The determination may be based upon previous success in resolving the event and descriptions of the related root cause.

Automated corrective actions are initiated when the system 212 determines a root cause to have a statistically significant correlation with a defined set of tasks leading to resolution. Where possible, the system 212 will utilize object-oriented constructs that represent known root causes. Likewise, there will be constructs that contain ordered steps to resolving problems. If a strong enough relationship exists between a defined root cause in the model and a resolution construct, the system 212 will be able to act autonomously to resolve the issue. Operators may retain the option of interrupting or preventing the automated corrective action at any time.

In one embodiment, in addition to automated and suggested corrective actions, users have capability to define their own paths to resolution of events. In this embodiment, the system 212 may monitor successful tasks for future use in automatically and manually resolving events.

If an automatic resolution is possible, the decision analysis and resolution system 212 goes to block 312. If an automatic resolution is possible, the decision analysis and resolution system 212 goes to block 314.

In block 312, the decision analysis and resolution system 212 automatically resolves the event. In an object-oriented network 100, root cause objects may be related to a series of other objects, where the other objects are associated with steps for resolving the event. In one embodiment, an event associated with a root cause of “high bandwidth utilization” is automatically resolved by the system 212 through rerouting of traffic and load balancing. The system 212 may keep the operator informed through updates to the trouble ticket while completing block 312. After block 312, the decision analysis and resolution system 212 goes to block 316.

In block 314, the decision analysis and resolution system 212 guides the user through the resolution of the event. The system 212 may guide users through the resolution process by presenting them with suggested corrective actions. The system 212 evaluates the strength of relationships between root cause constructs and resolution constructs. The system 212 identifies relationships with the highest correlation percentages between root cause objects and resolution constructs. A trouble ticket may be automatically generated. The system 212 may utilize embedded network 100 intelligence to provide a series of candidate steps for the users to follow toward resolution.

In block 314, the decision analysis and resolution system 212 presents data related to the event to the user. The system 212, by utilizing the object-oriented common data model 214 and the relationship between the event and responses and other network 100 components, displays cohesive information to the user in a simple and consistent format.

In block 314, the system 212 may relate root cause objects to a series of other objects, where the other objects are associated with steps for resolving the event. In block 314, the system 212 may utilize the trouble ticket and the embedded intelligence of the object-oriented constructs to provide a series of candidate steps for the user to follow to resolve the event. In block 314, the system 212 may utilize the object-oriented model 214 to define object constructs that can then be presented to users in context. For example, the system may utilize the object-oriented model 214 to define object constructs such as network elements presented visually in the context of a security failure, as opposed to network elements presented visually in the context of a failed router. The visual depiction of various types of events and resolutions in context is likely to trigger a user's memory so users can better associate events with steps to resolving the events.

By creating an adjunct to a domain's existing monitoring system, the system 212 visualization is tailored to the domain to which it is applied. This extension adds problem resolution services to the existing monitoring system's problem identification process. These problem resolution services may include a viewable list of identified solutions associated with the current event, as well as a display for users to update existing solutions, or add new solutions as the new solutions are discovered. The system 212 may also provide a searchable knowledge base for users to visually explore solutions and a screen to solicit feedback from users on the success of solutions that have been applied. This solicited information is then analyzed against a set of heuristics so that users can immediately see the probability of a solution's success.

In block 314, the systems 212 operation may be as basic as providing users with the location of technical manuals, repair guides, and other information necessary for event resolution. In increasingly complex implementations, the system 212 may guide the user or operator through resolution steps. Many network 100 elements can be presented to users in context, across all relevant domains, by extending objects in the common object model 214 to represent objects in the network visually, including the relevant attributes and relationships. As an example of one embodiment, network 100 elements with identified events presented to users as an overlay will offer users more discreet information about the event. After block 314, the decision analysis and resolution system 212 goes to block 316.

In block 316, the system 212 revises its datastores based on the event resolution of block 314. The system 212 is configured to maintain links between events and solutions employed in blocks 312 and or 314, including unsuccessful solutions. Problems (tactical or strategic) occurring in one area of a network 100 are likely to occur in other areas of the network 100. The system 212 interfaces with existing replication techniques (such as directory services), known to those having ordinary skill in the art, to provide a means of distributing solutions to other operators associated with the network 100. This distribution allows operators to collaborate on forming the best set of solutions as they face network events. Similarly, the system 212 can collaborate with other systems in creating streamlined solutions for automatic implementation. In another embodiment, the refined solutions can be made available to designers for incorporation in the base set of solutions as new releases of the system 212 are deployed. Based upon the relationships between problems, affected nodes, and solutions, the system 212 is capable of creating solution packages that can be shared across the network 100. These packages incorporate the set of data required to describe a solution, and can also be created as a “catalog” to allow operators to view the solutions to potential problems prior to the observance of those problems within network 100.

In block 316, the system may also monitor successful completion of tasks in order to revise the systems 212 ability to determine whether automated resolutions are possible in the future to resolve similar events. The system 212, tracks the solutions used by the operators to provide heuristics for future operators to gauge their solutions against. By tracking operator satisfaction and tracking solution efficiency, the system 212 is capable of not only providing the set of available solutions to the operator, but also of assisting the operator in selecting the most appropriate (or most likely to succeed) solution. Those having ordinary skill in the art are familiar with related heuristic processes provided on websites such as Amazon.com.

In one embodiment, the system 212 monitors operator actions during resolution and creates new solutions based on operator actions. Similarly, if existing solutions are optimized during the course of resolution, the system 212 is capable of altering the relationships between steps to create a streamlined solution for automatic or manual implementation. Statistics collected during system 212 operation may be utilized to determine how these relationships are broken and rejoined to refine and add to the available solution set.

In another embodiment, the decision analysis and resolution system 212 is utilized to train users. The system 212 is configured to allow users to resolve simulated scenarios where a list of solution steps is pre-defined in the system 212. When the user makes an error, the system 212 is configured to direct the user to the appropriate step in the solution or provide other assistance. The system 212 is also configured to provide hints or information from the object-oriented knowledge base within the system 212 to aid them in accomplishing the current task.

In another embodiment, the decision analysis and resolution system 212 is configured to act as a task-oriented guide when the user attempts to diagnose and resolve an event. The system 212 redefines source material from maintenance manuals as objects and relationships in the system 212 knowledge base. These objects are then presented in a wizard-like tool in the software. Operators can access the steps they require to resolve an event. When there are new solutions or improvements to existing solutions, the operators can add them to the knowledge base for future use.

In another embodiment, the decision analysis and resolution system 212 includes an a resolution module, and a solution module. The resolution module is configured to generate a proposed response to a detected root cause or detected event. The solution module is configured to resolve the detected event using the proposed response. The solution module may include functionality noted in regards to blocks 310, 312, and 314. The resolution module may further include a heuristics module configured to track proposed responses to detected events. The heuristics module may be configured to correlate the proposed responses to successful and unsuccessful resolutions of detected events. The heuristic module may include the functionality described in regard to block

In another embodiment, the decision analysis and resolution system 212 is configured to improve business processes. Monitoring and improvement of both factory floor and professional processes (e.g., engineering) can be achieved by encoding business process events and their relationships into objects within an information model. An institutionalized business process model, such as, but not limited to, the CMMI (Capability Maturity Model-Integrated, from the Carnegie Mellon Software Institute) can be encoded as the source of the underlying model of a system 212 based process improvement tool for project managers. The system 212 provides monitoring and control functions to support the business in determining the impact of incomplete or skipped activities, and the system 212 suggests appropriate resolution steps.

Flowchart 300 shows the architecture, functionality, and operation of a possible implementation of the decision analysis and resolution system 212. The blocks represent modules, segments, and/or portions of code. The modules, segments, and/or portions of code include one or more executable instructions for implementing the specified logical function(s). In some implementations, the functions noted in the blocks may occur in a different order than that shown in FIG. 3. For example, two blocks shown in succession in FIG. 3 may be executed concurrently or the blocks may sometimes be executed in another order, depending upon the functionality involved.

All of the systems and methods disclosed and claimed herein can be made and executed without undue experimentation in light of the present disclosure. It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A method for decision analysis and resolution, wherein an event is associated with a root cause, the method comprising the steps of:
relating a solution to the root cause;
determining whether the solution can resolve the event automatically;
automatically resolving the event when the event can be resolved automatically; and
providing information for resolving the event to a user when the event cannot be resolved automatically.

2. The method of claim 1, wherein the step of relating a solution to a root cause includes utilizing a solutions catalog.

3. The method of claim 1, wherein the step of relating a solution to a root cause includes chaining a series of solution objects to the root cause.

4. The method of claim 1, wherein the step of relating a solution to a root cause includes interoperating with a trouble ticket system.

5. The method of claim 1, wherein the events are related to object oriented constructs, wherein the object oriented constructs include underlying intelligence, wherein the intelligence includes relationships between the underlying object oriented constructs, wherein the step of determining whether the solution can resolve the event automatically utilizes the intelligence and the relationships to evaluate the validity of the solution.

6. The method of claim 5, wherein the validity of the solution is based upon previous success in resolving the event and descriptions of the related root cause.

7. The method of claim 5, wherein the validity of the solution is based upon previous success in resolving the event and descriptions of the related root cause.

8. The method of claim 1, wherein the step of determining whether the solution can resolve the event automatically includes determining whether a root cause has a statistically significant correlation with a defined set of tasks leading to a resolution of the event.

9. The method of claim 1, wherein the step of determining whether the solution can resolve the event automatically includes using object-oriented constructs.

10. The method of claim 1, wherein the step of determining whether the solution can resolve the event automatically includes allowing a user to prevent automated resolution.

11. The method of claim 1, wherein the step of automatically resolving the event includes providing information to a user by updating a trouble ticket.

12. The method of claim 1, wherein the step of providing information for resolving the event to a user includes presenting the user with suggested corrective actions.

13. The method of claim 1, wherein the step of providing information for resolving the event to a user includes evaluating the strength of relationships between a root cause construct and a resolution construct.

14. The method of claim 1, wherein the step of providing information for resolving the event to a user includes utilizing an object oriented model to define object constructs, wherein the constructs are then presented to the user.

15. The method of claim 1, wherein the step of providing information for resolving the event to a user includes a visualization of the information for resolving the event.

16. The method of claim 1, wherein the step of providing information for resolving the event to a user includes a visualization of the information for resolving the event, wherein the visualization includes providing an overlay, wherein the overlay offers information about the event.

17. The method of claim 1, wherein the step of providing information for resolving the event to a user includes providing a searchable knowledge base.

18. The method of claim 1, wherein the step of providing information for resolving the event to a user includes presenting a probability, wherein the probability is indicative of the success of the solution.

19. The method of claim 1, wherein the method is practiced in a network, further including the step of revising the network based on data generated while resolving the event.

20. The method of claim 19, wherein the step of revising the network includes revising a datastore within the network based on the event resolution.

21. The method of claim 1, wherein the method is practiced in a network, further including the step of distributing solutions in the network.

22. The method of claim 1, wherein the method is practiced in a network, further including the step of creating heuristics related to the solution, wherein the heuristics are configured to be available within the network to evaluate proposed solutions.

23. The method of claim 1, wherein the event is associated with a security fault.

24. The method of claim 1, wherein the event is associated with a network operational fault.

25. A network system configured to resolve network problem events correlated to root causes in an object-oriented environment, including:
a resolution module configured to generate a proposed response to the detected event; and
a solution module configured to resolve the detected event using the proposed response,
wherein the resolution module is configured to cooperate with the solution module to automatically implement the proposed response,
wherein the resolution module is configured to cooperate with the solution module to present the proposed response as a suggested response to resolve the detected event.

26. The system of claim 25, further including a user input module configured to allow a network user to initiate implementation of the proposed response.

27. The system of claim 25, wherein the resolution module further includes a heuristics module configured to track proposed responses to detected events.

28. The system of claim 27, wherein the heuristics module is configured to correlate proposed responses to successful and unsuccessful resolutions of detected events.

29. The system of claim 28, wherein the heuristics module is configured to solicit new responses to detected events based upon previous successful resolutions of similar detected events.

30. The system of claim 28, wherein the heuristics module is configured to present suggested responses to detected events based upon previous successful resolutions of similar detected events.

31. The system of claim 27, wherein the heuristics module is configured to generate automated responses to detected events based upon previous successful resolutions of similar previously selected responses.

32. The system of claim 31, wherein the heuristics module is configured to generate the automated responses based upon a predetermined success threshold for previously detected events.

33. The system of claim 32, wherein the heuristics module is configured to generate automated responses based upon previous optional responses once a success threshold for the previous optional responses has been reached.

34. A computer readable medium for decision analysis and resolution, wherein an event is associated with a root cause, the computer readable medium comprising:
logic for relating a solution to the event based on the root cause;
logic for determining whether the solution can resolve the event automatically;
logic for automatically resolving the event when the event can be resolved automatically; and
logic for providing information for resolving the event to a user when the event cannot be resolved automatically.

35. The computer readable medium of claim 34, wherein the logic for relating a solution to a root cause includes utilizing a solutions catalog.

36. The computer readable medium of claim 34, wherein the logic for relating a solution to a root cause includes chaining a series of solution objects to the root cause.

37. The computer readable medium of claim 34, wherein the logic for relating a solution to a root cause includes interoperating with a trouble ticket system.

38. The computer readable medium of claim 34, wherein the events are related to object oriented constructs, wherein the object oriented constructs include underlying intelligence, wherein the intelligence includes relationships between the underlying object oriented constructs, wherein the logic for determining whether the solution can resolve the event automatically utilizes the intelligence and the relationships to evaluate the validity of the solution.

39. The computer readable medium of claim 38, wherein the validity of the solution is based upon previous success in resolving the event and descriptions of the related root cause.

40. The computer readable medium of claim 38, wherein the validity of the solution is based upon previous success in resolving the event and descriptions of the related root cause.

41. The computer readable medium of claim 34, wherein the logic for determining whether the solution can resolve the event automatically includes determining whether a root cause has a statistically significant correlation with a defined set of tasks leading to a resolution of the event.

42. The computer readable medium of claim 34, wherein the logic for determining whether the solution can resolve the event automatically includes using object-oriented constructs.

43. The computer readable medium of claim 34, wherein the logic for determining whether the solution can resolve the event automatically includes allowing a user to prevent automated resolution.

44. The computer readable medium of claim 34, wherein the logic for automatically resolving the event includes providing information to a user by updating a trouble ticket.

45. The computer readable medium of claim 34, wherein the logic for providing information for resolving the event to a user includes presenting the user with suggested corrective actions.

46. The computer readable medium of claim 34, wherein the logic for providing information for resolving the event to a user includes evaluating the strength of relationships between a root cause constructs and a resolution construct.

47. The computer readable medium of claim 34, wherein the logic for providing information for resolving the event to a user includes utilizing an object oriented model to define object constructs, wherein the constructs are then presented to the user.

48. The computer readable medium of claim 34, wherein the logic for providing information for resolving the event to a user includes a visualization of the information for resolving the event.

49. The computer readable medium of claim 34, wherein the logic for providing information for resolving the event to a user includes a visualization of the information for resolving the event, wherein the visualization includes providing an overlay, wherein the overlay offers information about the event.

50. The computer readable medium of claim 34, wherein the logic for providing information for resolving the event to a user includes providing a searchable knowledge base.

51. The computer readable medium of claim 34, wherein the logic for providing information for resolving the event to a user includes presenting a probability, wherein the probability is indicative of the success of the solution.

52. The computer readable medium of claim 34, wherein the computer readable medium resides in a network, further including logic for revising the network based on data generated while resolving the event.

53. The computer readable medium of claim 52, wherein the logic for revising the network includes revising a datastore within the network based on the event resolution.

54. The computer readable medium of claim 34, wherein the computer readable medium resides in a network, further including logic for distributing solutions in the network.

55. The computer readable medium of claim 34, wherein the computer readable medium resides in a network, further including logic for creating heuristics related to the solution, wherein the heuristics are configured to be available within the network to evaluate proposed solutions.

56. The computer readable medium of claim 34, wherein the event is associated with a security fault.

57. The computer readable medium of claim 34, wherein the event is associated with a network operational fault.

58. A system for decision analysis and resolution, wherein an event is associated with a root cause, the system comprising:
means for relating a solution to the event based on the root cause;
means for determining whether the solution can resolve the event automatically;
means for automatically resolving the event when the event can be resolved automatically; and
means for providing information for resolving the event to a user when the event cannot be resolved automatically.

59. The system of claim 58, wherein the means for relating a solution to a root cause includes utilizing a solutions catalog.

60. The system of claim 58, wherein the means for relating a solution to a root cause includes chaining a series of solution objects to the root cause.

61. The system of claim 58, wherein the means for relating a solution to a root cause includes interoperating with a trouble ticket system.

62. The system of claim 58, wherein the events are related to object oriented constructs, wherein the object oriented constructs include underlying intelligence, wherein the intelligence includes relationships between the underlying object oriented constructs, wherein the means for determining whether the solution can resolve the event automatically utilizes the intelligence and the relationships to evaluate the validity of the solution.

63. The system of claim 62, wherein the validity of the solution is based upon previous success in resolving the event and descriptions of the related root cause.

64. The system of claim 62, wherein the validity of the solution is based upon previous success in resolving the event and descriptions of the related root cause.

65. The system of claim 58, wherein the means for determining whether the solution can resolve the event automatically includes determining whether a root cause has a statistically significant correlation with a defined set of tasks leading to a resolution of the event.

66. The system of claim 58, wherein the means for determining whether the solution can resolve the event automatically includes using object-oriented constructs.

67. The system of claim 58, wherein the means for determining whether the solution can resolve the event automatically includes allowing a user to prevent automated resolution.

68. The system of claim 58, wherein the means for automatically resolving the event includes providing information to a user by updating a trouble ticket.

69. The system of claim 58, wherein the means for providing information for resolving the event to a user includes presenting the user with suggested corrective actions.

70. The system of claim 58, wherein the means for providing information for resolving the event to a user includes evaluating the strength of relationships between a root cause constructs and a resolution construct.

71. The system of claim 58, wherein the means for providing information for resolving the event to a user includes utilizing an object oriented model to define object constructs, wherein the constructs are then presented to the user.

72. The system of claim 58, wherein the means for providing information for resolving the event to a user includes a visualization of the information for resolving the event.

73. The system of claim 58, wherein the means for providing information for resolving the event to a user includes a visualization of the information for resolving the event, wherein the visualization includes providing an overlay, wherein the overlay offers information about the event.

74. The system of claim 58, wherein the means for providing information for resolving the event to a user includes providing a searchable knowledge base.

75. The system of claim 58, wherein the means for providing information for resolving the event to a user includes presenting a probability, wherein the probability is indicative of the success of the solution.

76. The system of claim 58, wherein the computer readable medium resides in a network, further including means for revising the network based on data generated while resolving the event.

77. The system of claim 52, wherein the means for revising the network includes revising a datastore within the network based on the event resolution.

78. The system of claim 58, wherein the computer readable medium resides in a network, further including means for distributing solutions in the network.

79. The system of claim 58, wherein the computer readable medium resides in a network, further including means for creating heuristics related to the solution, wherein the heuristics are configured to be available within the network to evaluate proposed solutions.

80. The system of claim 58, wherein the event is associated with a security fault.

81. The system of claim 58, wherein the event is associated with a network operational fault.
